(19) United States
(12) Patent Application Publication
(10) Pub. No.: US 2023/0003327 A1
(43) Pub. Date: Jan. 5, 2023

(54) COUPLING

(71) Applicant: ENVIROCHASING IP HOLDINGS PTY LTD, Forrestdale, Western Australia (AU)

(72) Inventor: Steven TERPSTRA, Armadale (AU)

(21) Appl. No.: 17/757,089

(22) PCT Filed: Dec. 9, 2020
(86) PCT No.: PCT/AU2020/051351

§ 371 Date: Jun. 9, 2022

(30) Foreign Application Priority Data
Dec. 13, 2019 (AU) 2019904730

(51) Int. Cl. F16L 47/30; B23Q 11/00; F01N 13/18

(52) U.S. Cl. CPC F16L 47/30; B23Q 11/0046; F01N 13/1827; B23D 59/006

(57) ABSTRACT

A coupling (40) for connecting a suction line (31) to a first fluid flow and an exhaust gas flow, the coupling (40) comprising first and second portions (51, 52). The first portion (51) is adapted to receive an end section (34) of the suction line (31) and the second portion (52) is adapted to cooperate with the first portion (51) for engaging a portion of the end section (34) therebetween. The first portion (51) has an opening (63) for receiving an exhaust outlet (16, 17) configured to deliver an exhaust gas flow into the first portion (51). Engagement of the end section (34) between the first and second portions (51, 52) serves to compress a marginal portion of a side wall (37) or side port (36) in the end section (34) of the suction line (31). An apparatus (10) including a rotary tool element (19) and including the coupling (40) is also disclosed.

### TECHNICAL FIELD

This invention relates to coupling for connecting a suction line to a first fluid flow and an exhaust gas flow. The first fluid flow may comprise a fluid mixture, such as for example an air flow with entrained matter (such as dust and/or slurry).

Further, the invention relates to a suction line which may be used with such a coupling.

The invention also relates to a machine incorporating such a coupling. More particularly, the machine may feature an extraction apparatus and an internal combustion engine having an exhaust outlet, wherein the coupling is adapted to connect fluid flow from the extraction apparatus and exhaust gas from the engine exhaust, to a suction line for conveying the fluid flow and the exhaust gas away from the machine.

The invention also relates to apparatus incorporating the machine.

### BACKGROUND ART

The following discussion of the background art is intended to facilitate an understanding of the present invention only. The discussion is not an acknowledgement or admission that any of the material referred to is or was part of the common general knowledge as at the priority date of the application.

The invention has been devised particularly, although not necessarily solely, for use with a machine which is powered by an internal combustion engine and which is operable to perform working operations (such as cutting and chasing) in masonry surfaces such as brickwork and concrete surfaces.

It is often necessary to use such a machine within a confined environment such as internally within buildings, trenches and other closed working environments. In such circumstances, exhaust gas from the internal combustion engine is discharged into the closed environment and can accumulate to an extent where the exhaust gas often create hazardous working conditions. It is therefore desirable to remove the exhaust gas from the closed environment. This may be done by conveying the exhaust gas away along a suction line.

Further, with such a machine, dust and other debris generated by the working operation is typically contained and collected. The dust may be suppressed with a liquid, creating slurry. It is desirable that the slurry created during operation of the machine be controlled by being contained and collected, in order to maintain a clean and safe working environment.

In PCT/AU2017/051256 (WO 2018/090086) there is disclosed an extraction apparatus for containing and collecting the dust, typically within a slurry. Ambient air is also drawn into the extraction apparatus, creating a fluid mixture incorporating the dust (typically within a slurry) and any other cutting debris. The fluid mixture is conveyed away along a suction line.

It may be advantageous to connect the outlet of the extraction apparatus and the exhaust outlet of the engine to a common suction line.

The present invention seeks to provide a coupling for this purpose.

The present invention is, however, not necessarily limited to use with an extraction apparatus for containing and collecting dust (typically within a slurry) and any other debris. The invention may have application more broadly in cases in which there is a requirement to deliver a first fluid flow and an exhaust flow to a common suction line.

### SUMMARY OF INVENTION

According to a first aspect of the invention there is provided a coupling for connecting a suction line to a first fluid flow and an exhaust gas flow, the coupling comprising first and second portions, the first portion being adapted to receive an end section of the suction line and the second portion being adapted to cooperate with the first portion for engaging a portion of the end section therebetween, the first portion having an opening for receiving an exhaust outlet configured to deliver an exhaust gas flow into the first portion, wherein engagement of the end section between the first and second portions serves to compress a marginal portion of a side port in the end section of the suction line in registration with the opening in the first portion to establish a fluid seal around the opening.

Preferably, the engagement of the end section between the first and second portions comprises clamping engagement.

According to a second aspect of the invention there is provided a coupling for connecting a suction line to a first fluid flow and an exhaust gas flow, wherein the suction line comprises an end section having a side port, the coupling comprising first and second portions, and an opening for receiving an exhaust outlet whereby exhaust gas discharging from the exhaust outlet enters a flow path within the first portion, the first and second portions being adapted to engage the end section of the suction line therebetween with side port in registration with the opening, whereby engagement of the end section between the first and second portions compresses a marginal portion of the side wall bounding the port to establish a fluid seal around the opening.

Preferably, the engagement of the end section between the first and second portions comprises clamping engagement in each of the above aspects of the invention.

In each of the above aspects of the invention, the first and second portions may be adapted to be releasably secured together in a manner adapted to clampingly engage the end section of the suction line therebetween.

The coupling according to each of the above aspects of the invention may further comprise a securing means for releasably securing the first and second portions together in a manner adapted to clampingly engage the end section of the suction line therebetween

In each of the above aspects of the invention, the first portion may be configured as a tube having a side wall and two opposed ends, wherein the opening for receiving the exhaust gas outlet is provided in the side wall.

The opening in the side wall may be disposed between and spaced inwardly from the two opposed ends.

One end of the tube may be configured to receive a delivery line for the first fluid flow, and the other end may be configured to receive the end section of the suction line, wherein the delivery line communicates with the suction line via a flow path in the tube.

In each of the above aspects of the invention, the second portion may comprise a cradle for receiving the first portion (e.g. the tube).

The exhaust outlet may extend from the second portion (e.g. the cradle), wherein the exhaust outlet is received within the first portion (e.g. the tube) when the first and second portions are mounted together. In one arrangement, the exhaust outlet may extend from the cradle and the exhaust outlet may be receivable in the flow path within the tube through the opening in the side wall of the tube. In one arrangement, the cradle may be provided with an opening through which the exhaust outlet extends.

In each of the above aspects of the invention, the coupling may further comprise cooling means for cooling of the exhaust outlet, and more particularly that portion of the exhaust outlet receivable within the flow path.

The cooling means may comprise a water jacket.

The water jacket may comprise a water chamber having a water inlet and a water outlet.

The water inlet may be so positioned as to be located within the interior of the first portion (e.g. the tube) when the latter is mounted on the second portion (e.g. the cradle). The water outlet may be so positioned as to be located exteriorly of the first portion (e.g. the tube) when the latter is mounted on the second portion (e.g. the cradle).

The water jacket may be arranged to isolate the (hot) exhaust outlet from the second portion (e.g. the cradle) and also from the end section of the suction line when engaged between the first and second portions.

According to a third aspect of the invention there is provided a coupling for connecting a suction line to a first fluid flow and an exhaust gas flow, the coupling comprising means defining a flow path having first end for connection to the suction line and a second end for connection to the first fluid flow, said means being configured to communicate with an exhaust outlet whereby exhaust gas discharging from the exhaust outlet enters the flow path.

Preferably, said means is configured to communicate with the exhaust outlet by being adapted to receive the exhaust outlet (whereby exhaust gas discharging from the exhaust outlet enters the flow path). With such an arrangement, the exhaust outlet may be received within the flow path.

Preferably, said means defining the flow path comprises a body defining a passage which provides the flow path.

In this third aspect of the invention, said means is configured to communicate with the exhaust outlet may comprise the first portion referred to above in relation to the first or second aspect of the invention.

The coupling according to the third aspect of the invention may have any one or more of the features of the coupling according to the first or second aspect of the invention as specified above.

According to a fourth aspect of the invention there is provided a suction line comprising a hose having an end section for connection to a coupling, and a side port in the end section for communication with an opening in the coupling.

According to a fifth aspect of the invention there is provided a machine comprising an internal combustion engine having an exhaust outlet, a work head powered by the engine, wherein the work head has an extraction apparatus for extracting debris generated during a working operation performed by the work head, the extraction apparatus having an outlet through which debris can be discharged as a fluid flow, and a coupling for connecting the outlet of the extraction apparatus and the exhaust outlet of the engine to a common suction line, wherein the coupling comprises a coupling according to the first, second or third aspect of the invention.

The exhaust outlet of the engine may be provided by an outlet of a muffler on the engine. The outlet of the muffler may be configured as a pipe.

The exhaust outlet may be configured to direct exhaust gas into the first portion of the coupling (e.g. the tube) in a direction in which fluid would flow under the influence of suction exerted via the suction line.

According to a sixth aspect of the invention there is provided apparatus comprising:

a machine comprising an internal combustion engine having an exhaust outlet, and a work head powered by the engine,

wherein the work head has an extraction apparatus for extracting debris generated during a working operation performed by the work head,

the extraction apparatus having an outlet through which debris can be discharged as a fluid flow,

a coupling for connecting the outlet of the extraction apparatus and the exhaust outlet of the engine to a common suction line,

wherein the suction line comprises an end section and a side port, and

wherein the marginal portion of the suction line bounding the side port is adapted to be engaged by the coupling to compress the marginal portion to establish a fluid seal around the opening.

The coupling featured in the sixth aspect of the invention may comprises a coupling according to the first, second or third aspect of the invention

The extraction apparatus may comprise extraction apparatus as disclosed in PCT/AU2017/051256 (WO 2018/090086), the content of which are incorporated herein by way of reference.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic view of apparatus for performing a cutting or chasing operation on a wall or floor surface;

FIG. 2 is a schematic side view of a cutting machine forming part of the apparatus of FIG. 1;

FIG. 3 is a schematic perspective view of an embodiment of a coupling used with the cutting machine, the coupling being shown together with a muffler for an engine used to power the cutting machine;

FIG. 4 is a side view of the arrangement shown in FIG. 3;

FIG. 5 is a schematic perspective view of the coupling and an end section of a suction hose attached thereto;

FIG. 6 is a is a schematic perspective view of a first portion of the coupling;

FIG. 7 is a schematic perspective view of the end section of the suction hose;

FIG. 8 is a schematic perspective view of a second portion of the coupling and an associated securing means for securing the first and second portions of the coupling together;

FIG. 9 is a schematic perspective view of the second portion of the coupling shown together with the muffler;

FIG. 10 is a plan view of the arrangement shown in FIG. 9;

FIG. 11 is an end view of the arrangement shown in FIG. 9;

FIG. 12 is a side view of the arrangement shown in FIG. 9; and

FIG. 13 is a schematic perspective view of a further embodiment of the coupling shown together with the muffler.

The drawings shown are not necessarily to scale, with emphasis instead generally being placed upon illustrating the principles of the present invention.

The figures depict embodiments of the invention. The embodiments each illustrates a certain configuration; however, it is to be appreciated that the invention can take the form of many configurations, as would be obvious to a person skilled in the art, whilst still embodying the present invention. These configurations are to be considered within the scope of this invention

### DESCRIPTION OF EMBODIMENTS

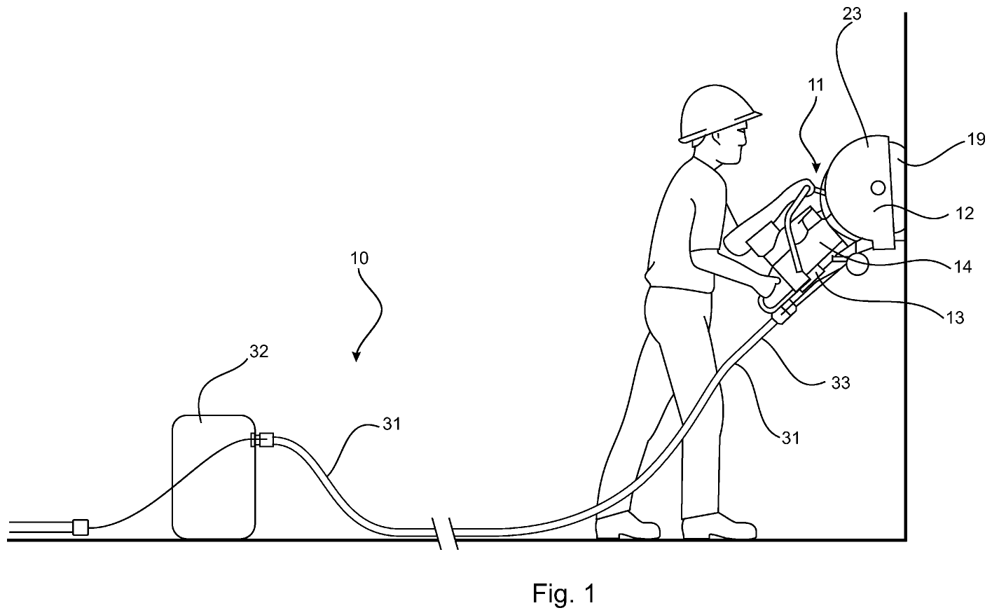

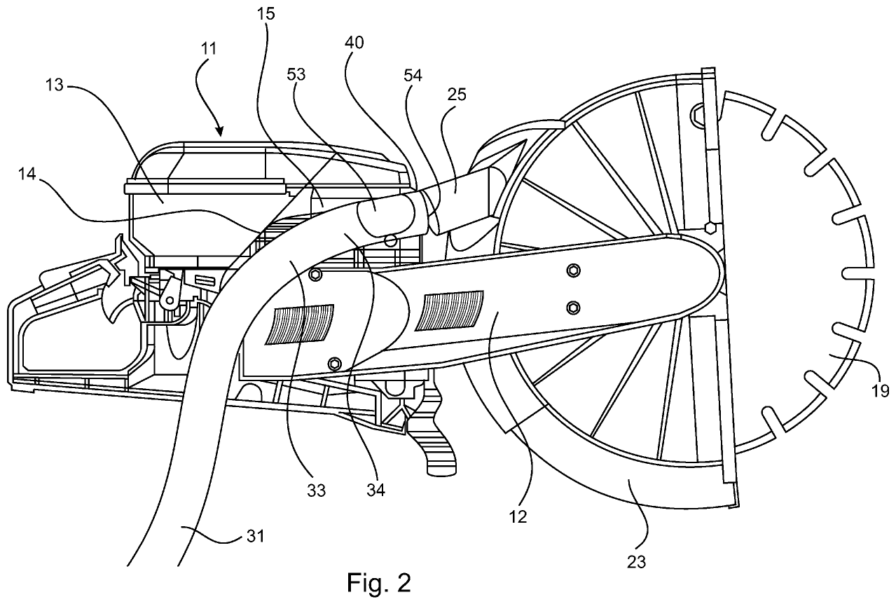

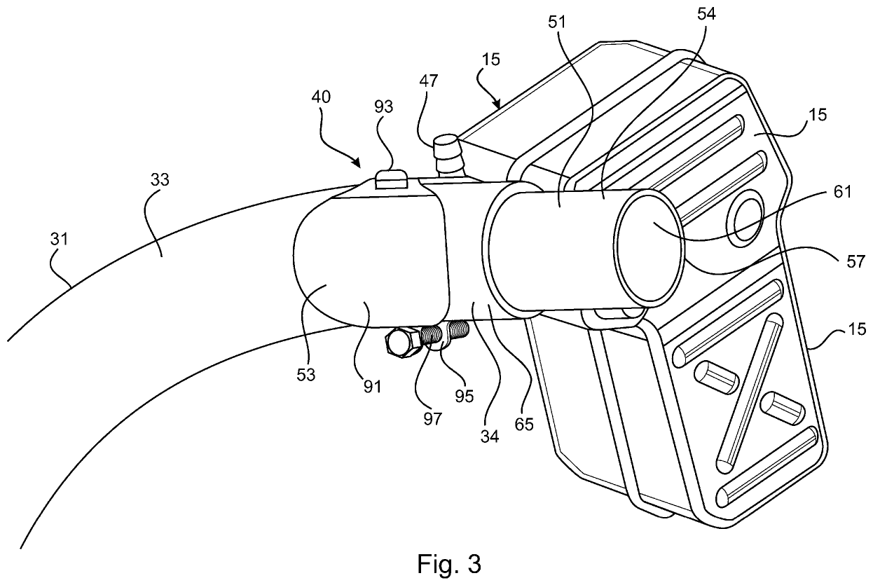

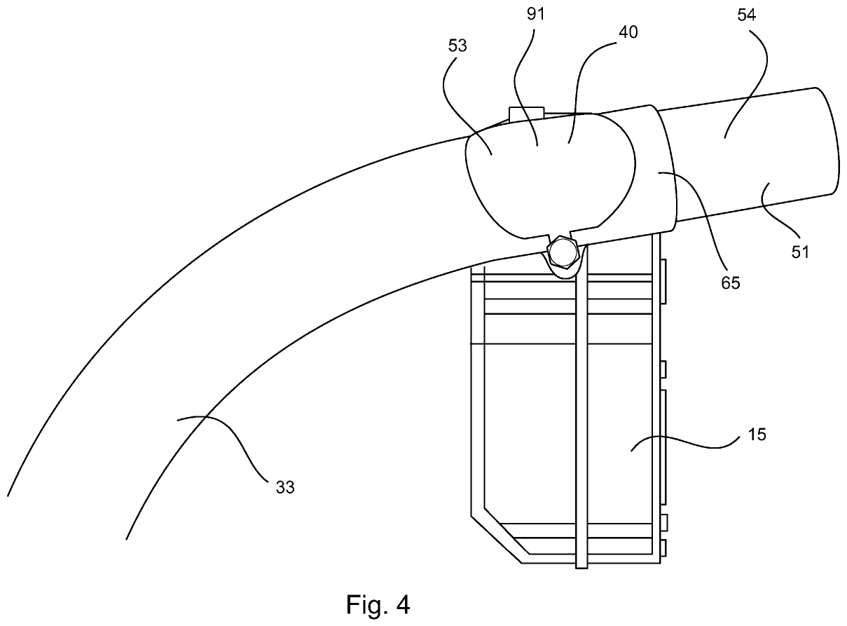

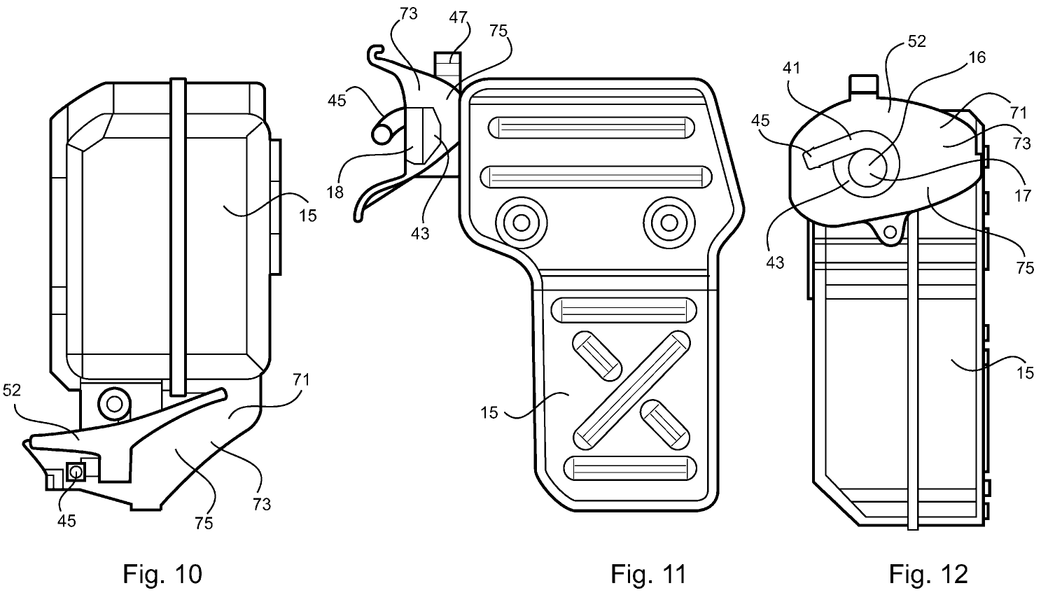

Referring to FIGS. 1 to 12 of the drawings, there is shown apparatus 10 for performing a cutting or chasing operation on a wall or floor surface. The apparatus 10 comprises a cutting machine 11 which in the arrangement shown is a hand-held unit (as seen in FIG. 1). Other arrangements are contemplated, including for example a cutting machine mounted on a mobile base for movement over a surface in which a cutting or chasing operation is to be performed.

The cutting machine 11 comprises a work head 12 and a body 13 supporting the work head. The body 13 incorporates an internal combustion engine 14 for powering the work head 12. The engine 14 may, for example, comprise a two-stroke petrol engine. The engine 14 is fitted with a muffler 15 having an exhaust outlet 16 for engine exhaust gas. The exhaust outlet 16 is configured as a pipe 17 having an outer end section 18 configured to direct exhaust gas in a particular direction (as will be explained further later).

The work head 12 receives and supports a rotary tool element 19 which in the arrangement shown is in the form of a rotatable circular blade, such as for example a diamond segmented blade, a saw blade or an abrasive disc.

During operation of the cutting machine 11, dust and debris (e.g. other particulates such as fragments) are typically generated, and there is a need to control the dust and debris. For this purpose, the cutting machine 12 has a facility to deliver a dust suppression liquid (such as water), with the result that a slurry is generated.

There is a need to control the slurry, otherwise it may spill and spray about the worksite, and also accumulate at the worksite. For this purpose, the cutting machine 11 is fitted with an extraction apparatus 23 to control of the slurry. The extraction apparatus 23 is adapted to contain dust and other debris generated during operation of the cutting apparatus 11, as well as slurry formed from the dust, and to facilitate extraction of the dust, other debris and slurry as a fluid flow under the influence of suction. The fluid flow also comprises air drawn into the extraction apparatus from ambient air at the work site. Accordingly, the fluid flow may comprise a fluid mixture of air, dust, other debris, and/or slurry.

The extraction apparatus 23 has an outlet 25 through which the fluid mixture is drawn under the influence of suction.

The extraction apparatus may, for example, comprise apparatus as disclosed in PCT/AU2017/051256 (WO 2018/090086), the content of which are incorporated herein by way of reference.

A suction line 31 communicating with a suction source 32 is arranged to provide requisite suction for extraction of the dust, other debris and slurry from the extraction apparatus 23, and also for extraction of exhaust gas discharging from the exhaust outlet 16 of the muffler 15.

The suction line 31 comprises a suction hose 33 having an end section 34 terminating at end 35, and a side port 36 extending through the side wall 37 of the hose inwardly of the end 35. The side port 36 comprises a hole 38 formed in the side wall 37, thereby providing a marginal portion 39 of the side wall around the hole 38. The marginal portion 39 thus bounds the side port 36.

The suction hose 33 may comprise a silicone rubber hose, although other suitable hoses are also contemplated.

Coupling 40 is provided to communicate fluid flow from the extraction apparatus 23 (typically a fluid mixture comprising air, other debris, dust and/or slurry, as mentioned above) and exhaust gas from the exhaust outlet 16 of the muffler 15, with the suction line 31. In this way, the suction line 31 can carry the fluid flow and the exhaust gas away from the working environment in which the cutting machine 12 is operating (for subsequent disposal).

It is desirable that the exhaust outlet 16 of the muffler 15, as well as the discharging exhaust gas, be cooled to an extent such as to not cause heat damage to the suction hose 33. Accordingly, a cooling means 41 for cooling of the exhaust outlet 16, and more particularly that portion of the exhaust outlet 16 receivable within the coupling 40. In the arrangement shown, the cooling means 41 comprises a water jacket 43 fitted around the pipe 17 of the exhaust outlet 16. The water jacket has a water inlet 45 and a water outlet 47.

The exhaust gas is also cooled using the cooling effects of the fluid flow from the extraction apparatus 23, with which the exhaust gas mixes within the coupling 40, as will become apparent later. The cooling effects of the fluid flow from the extraction apparatus 23 arise because of the presence of air and water in the fluid mixture which constitutes the fluid flow. It is notable also that in mixing with the exhaust gas in the coupling 40, the fluid flow from the extraction apparatus 23 also dilutes the exhaust gas (predominately due to the air within the fluid mixture which constitutes the fluid flow).

The coupling 40 comprises first and second portions 51, 52 adapted to clampingly engage the end section 34 of the suction hose 33 therebetween. The coupling 40 further comprises securing means 53 for releasably securing the first and second portions 51, 52 together in a manner adapted to clampingly engage the end section 34 of the suction hose 33.

The first portion 51 comprises a tube 54 having a side wall 55 and two opposed ends 56, 57. The side wall 55 has an outer surface 58, a portion 58a of which presents an inner clamping face 59 intermediate the two ends 56, 57. The interior of the tube 54 defines a flow passage 61 which extends between the two ends 56, 57. An opening 63 is provided within that portion 58a of the side wall 55 which presents an inner clamping face 59. The opening 63 is configured to receive the pipe 17 of the exhaust outlet 16 and the associated water jacket 43, including the water inlet 45 (as will be explained in more detail later).

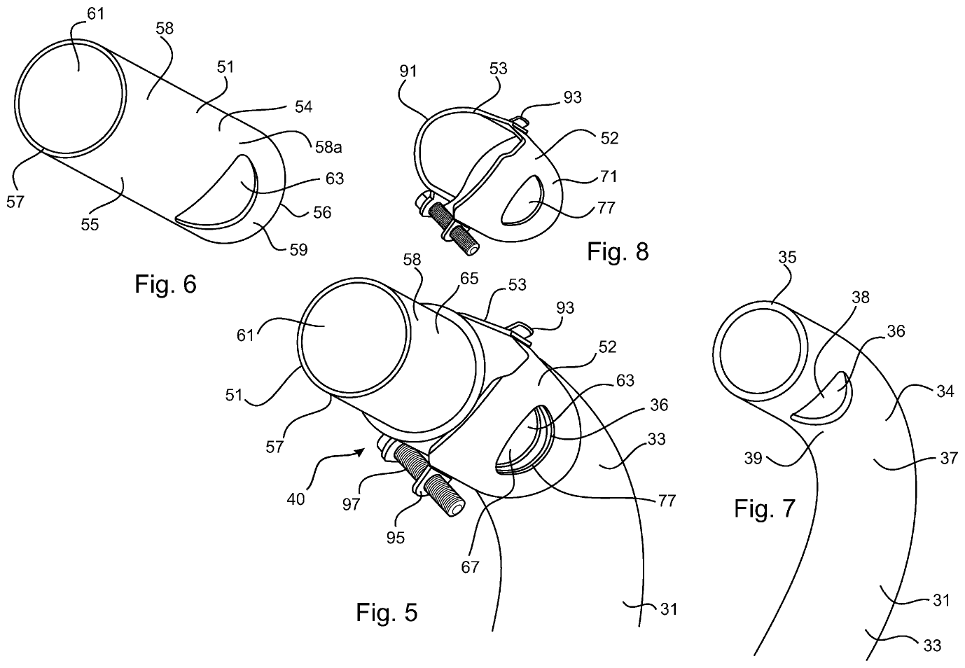

End 56 of tube 54 is adapted to receive the end section 34 of the suction hose 33, with the opening 63 in the tube 54 registering with the side port 36 in the suction hose 33 (as best seen in FIG. 5). The end 56 of tube 54 receives the end section 34 of the suction hose 33 by the end section 34 of the suction hose 33 being positioned over end 56 of the tube 54. In other words, the end 56 of the tube 54 is received within the suction hose 33. In this way, the suction hose 33 communicates with flow passage 61 within the coupling 40.

End 57 of tube 54 is adapted to be connected to an outlet 25 of the extraction apparatus 23. With this arrangement, suction induced by suction hose 33 has the effect of generating a fluid flow through the outlet 25, conveying air, dust and/or slurry from the extraction apparatus 23 as a fluid mixture to flow passage 61 within the coupling 40. In other words, the suction hose 33 communicates with the outlet 25 of the extraction apparatus 23 to provide the requisite suction effect at the outlet 25 to generate fluid flow through the outlet 25 (as described).

In practical terms, the tube 54 and the end section 34 of the suction hose 33 together provide an assembly 65. The assembly 65 has a lateral port 67 defined by the opening 63 in the tube 54 and the side port 36 in the suction hose 33 being in registration, as previously described.)

The second portion 52 comprises a cradle 71 for receiving the tube 54. More particularly, the cradle 71 is configured to receive the assembly 65 (i.e. the end section 35 of the suction hose 33, with the tube 54 received within the end section 35).

The cradle 71 presents a surface 73 which provides an outer clamping face 75. An opening 77 is provided within the cradle 71 to accommodate the exhaust outlet 16 and the water jacket 43.

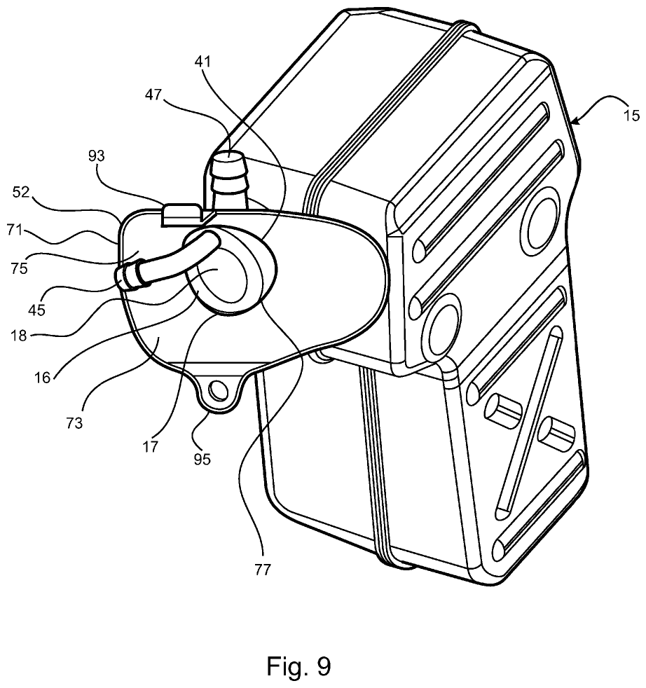

The cradle 71 is mounted on the muffler 15, with the exhaust outlet 16 and the water jacket 43 extending through the opening 77 and beyond the outer clamping face 75, as best seen in FIGS. 9, 11 and 12. With this arrangement, the water jacket 43 isolates the hot exhaust outlet 16 (and in particular the exhaust pipe 17) from the cradle 71 and also from the end section 35 of the suction hose 33 (when received on the cradle).

The cradle 71 may be secured to the muffler 15 in any appropriate way, such as by spot welding.

The cradle 71 is configured to receive the assembly 65, with the assembly 65 being presented to the cradle in a manner such that the lateral port 67 of the assembly is aligned with and receives the exhaust outlet 16 and the water jacket 43. With this arrangement, the end section 35 of the suction hose 33 is disposed between the tube 54 and the cradle 71. More particularly, end section 35 of the suction hose 33 is disposed between the outer clamping face 75 defined by the cradle 71 and the inner clamping face 59 defined by the tube 54. Further, the exhaust pipe 17 of the exhaust outlet 15 opens onto the interior of the tube 54 so as to communicate with the flow passage 61 for discharging exhaust gas into the flow passage. The outer end section 18 of the exhaust pipe 17 is configured to direct exhaust gas in direction towards the suction hose 34. In this way, the discarding exhaust gas is introduced into the flow passage to flow in a direction corresponding to fluid flow induced in the flow passage from end 57 to end 56 by a suction effect created by the suction hose 33.

With the end section 35 of the suction hose 33 disposed between the outer clamping face 75 defined by the cradle 71 and the inner clamping face 59 defined by the tube 54, the marginal portion 39 bounding the side port 36 in the end section 34 of the suction hose 33 undergoes compression when the inner and outer clamping faces 59, 75 are drawn together by the action of the securing means 53. Because of the inherent flexible nature of the suction hose 33 (and particularly so in this embodiment in which the suction hose comprises silicone rubber), the compression establishes a fluid seal around the opening 63 in the tube 54. In other words, the compression establishes a fluid seal between the cradle 71 and the tube 54 around the exhaust outlet 16 and the water jacket 43.

In this embodiment, the securing means 53 comprises a retaining plate 91 attached to the cradle 71 by way of clip 93 and tab 95. The retaining plate is connected to the tab 95 by way of retaining bolt 97. With this arrangement, the retaining plate 91 can be either removed or tightened (to increase the compression of the end section 35 of the suction hose 33 disposed between the outer clamping face 75 and the inner clamping face 59).

As alluded to above, water inlet 45 is accommodated within the interior of tube 54 when the assembly 65 is mounted on the cradle 71. In this way, a water supply line (not shown) for delivering water to the inlet 45 can be accommodated within and extend along the interior of suction hose 43. Accommodating the water supply line within the confines of the suction hose 31 is advantageous, as it avoids the presence of a further exposed hose at the work site requiring additional handling and also potentially presenting a safety hazard.

The water outlet 47 is located exteriorly of the tube 54. The water outlet 47 may communicate with a water supply arrangement for the extraction apparatus 23; that is, water for injection into the extraction apparatus 23 for dust control and to generate slurry is derived from the water outlet 47.

The opening 63 is configured to receive the pipe 17 of the exhaust outlet 16 and the associated water jacket 43, including the water inlet 45.

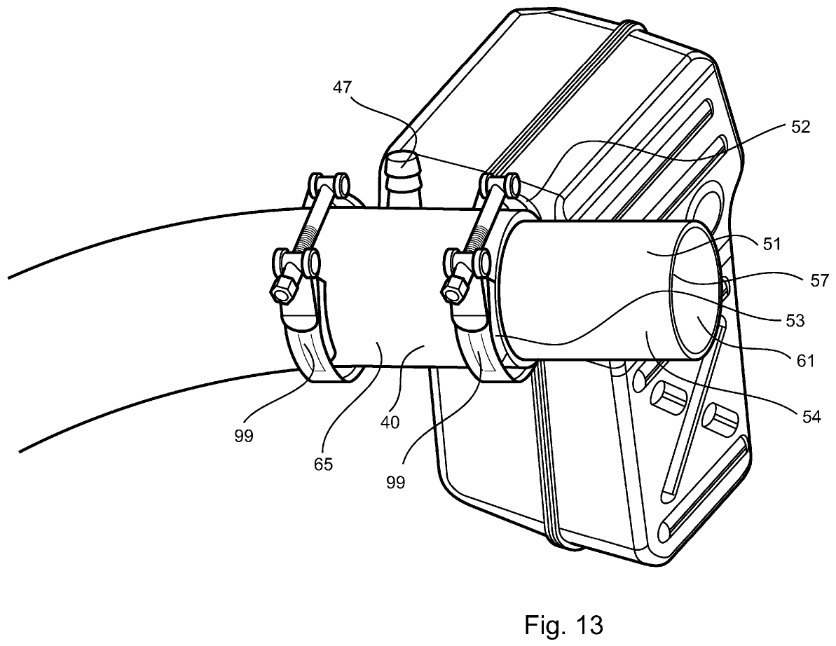

Referring now to FIG. 13, there is shown a second embodiment of coupling 40, in which the securing means 53 is configured as two pipe clamps 99 operable to releasable secure the assembly 65 to the second portion 52 (i.e. cradle 71).

From the foregoing, it is evident that each embodiment of coupling 40 provides a simple yet highly effective way of connecting the suction line 31 for extraction of the dust and slurry from the extraction apparatus 23 and also extraction of exhaust gas discharging from the exhaust outlet 16 of the muffler 15. Further, the coupling 40 can be readily detached to provide access to the exhaust outlet 15 as might be necessary. This is considered to be advantageous; for example, in the event of the exhaust outlet 15 requiring servicing to remove any slurry accumulation which might clog or restrict exhaust gas flow.

Detachment of the coupling 40 simply requires that the securing means 53 be released, thereby allowing the assembly 65 to be moved sidewardly out of the cradle 71. As the assembly 65 is removed from the cradle 71, the lateral port 67 withdraws from around the exhaust outlet 16 and the water jacket 43. The coupling 40 can be returned into position by presenting the assembly 65 sidewardly to the cradle 71, with the lateral port 67 locating around the exhaust outlet 16 and the water jacket 43. The securing means 53 can then be installed to effect compression of the end section 35 of the suction hose 33 disposed between the outer clamping face 75 and the inner clamping face 59 and thereby establish a fluid seal between the cradle 71 and the tube 54 around the exhaust outlet 16 and the water jacket 43.

The foregoing disclosure is intended to explain how to fashion and use the particular embodiment described, rather than to limit the true, intended, and fair scope and spirit of the invention. The foregoing description is neither intended to be exhaustive, nor to be limited to the precise forms disclosed.

Further, it should be appreciated that various modifications can be made without departing from the principles of the invention. Therefore, the invention should be understood to include all such modifications within its scope.

The terminology used herein is for the purpose of describing particular example embodiments only and is not intended to be limiting.

As used herein, the singular forms “a”, “an” and “the” may be intended to include the plural forms as well, unless the context clearly indicates otherwise.

The method steps, processes, and operations described herein are not to be construed as necessarily requiring their performance in the particular order discussed or illustrated, unless specifically identified as an order of performance. It is also to be understood that additional or alternative steps may be employed.

Reference to any positional descriptions, such as “top”, “bottom” and “side”, are to be taken in context of the embodiments described (and depicted in the drawings in the case of the first embodiment), and are not to be taken as limiting the invention to the literal interpretation of the term but rather as would be understood by the skilled addressee.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Additionally, where the terms “system”, “device”, and “apparatus” are used in the context of the invention, they are to be understood as including reference to any group of functionally related or interacting, interrelated, interdependent or associated components or elements that may be located in proximity to, separate from, integrated with, or discrete from, each other.

Throughout this specification, unless the context requires otherwise, the word “comprise” or variations such as “comprises” or “comprising”, will be understood to imply the inclusion of a stated integer or group of integers but not the exclusion of any other integer or group of integers.

1-26. (canceled)

27. A coupling for connecting a suction line to a first fluid flow and an exhaust gas flow, wherein the suction line comprises an end section having a side port, the coupling comprising first and second portions, and an opening for receiving an exhaust gas outlet whereby exhaust gas discharging from the exhaust outlet enters a flow path within the first portion, the first and second portions being adapted to engage the end section of the suction line therebetween with the side port in registration with the opening, whereby engagement of the end section between the first and second portions compresses a marginal portion of the side wall bounding the port to establish a fluid seal around the opening.

28. The coupling of claim 27, wherein the engagement of the end section between the first and second portions comprises clamping engagement.

29. The coupling of claim 27, wherein the first and second portions are adapted to be releasably secured together in a manner adapted to clampingly engage the end section of the suction line therebetween.

30. The coupling of claim 27, further comprising a securing means for releasably securing the first and second portions together in a manner adapted to clampingly engage the end section of the suction line therebetween.

31. The coupling of claim 27, wherein the first portion is configured as a tube having a side wall and two opposed ends, wherein the opening for receiving the exhaust gas outlet is provided in said side wall.

32. The coupling of claim 31, wherein said opening in said side wall is disposed between and spaced inwardly from the two opposed ends.

33. The coupling of claim 31, wherein said tube is configured to receive a delivery line for the first fluid flow, and the other end is configured to receive the end section of the suction line, wherein said delivery line communicates with the suction line via a flow path in the tube.

34. The coupling of claim 27, wherein said second portion comprises a cradle for receiving said first portion.

35. The coupling of claim 27, wherein said exhaust outlet extends from the second portion, wherein said exhaust outlet is received within said first portion when the first and second portions are mounted together.

36. The coupling of claim 34, wherein said exhaust outlet extends from said cradle and the exhaust outlet is receivable in the flow path within the tube through the opening in the side wall.

37. The coupling of claim 36, wherein said cradle is provided with an opening through which said exhaust outlet extends.

38. The coupling of claim 27, further comprising cooling means for cooling of the exhaust outlet.

39. The coupling of claim 38, wherein a portion of the exhaust outlet receivable within the flow path is cooled by said cooling means.

40. The coupling of claim 38, wherein said cooling means comprises a water jacket.

41. The coupling of claim 40, wherein said water jacket comprises a water chamber having a water inlet and a water outlet, said water inlet being positioned so as to be located within an interior of the first portion when said first portion is mounted on said second portion with said water outlet optionally being positioned so as to be located exteriorly of said first portion when said first portion is mounted on said second portion.

42. The coupling of claim 41, wherein said water jacket is arranged to isolate said exhaust outlet from said second portion and also from the end section of the suction line when engaged between said first and second portions.

43. A coupling for connecting a suction line to a first fluid flow and an exhaust gas flow, the coupling comprising means defining a flow path having a first end for connection to the suction line and a second end for connection to the first fluid flow, said flow path defining means being configured to communicate with an exhaust outlet whereby exhaust gas discharging from said exhaust outlet enters said flow path.

44. The coupling of claim 43, wherein said flow path defining means is configured to communicate with the exhaust outlet by being adapted to receive the exhaust outlet such that said exhaust outlet is received within the flow path.

45. The coupling of claim 43, wherein said flow path defining means comprises a body defining a passage which provides the flow path.

46. A machine comprising an internal combustion engine having an exhaust outlet; and a work head powered by the engine, wherein the work head has an extraction apparatus for extracting debris generated during a working operation performed by the work head, said extraction apparatus having an outlet through which debris can be discharged as a fluid flow, and a coupling for connecting the outlet of the extraction apparatus and the exhaust outlet of the engine to a common suction line, wherein said coupling comprises first and second portions, and an opening for receiving an exhaust gas outlet whereby exhaust gas discharging from the exhaust outlet enters a flow path within the first portion, the first and second portions being adapted to engage the end section of the suction line therebetween with the side port in registration with the opening, whereby engagement of the end section between the first and second portions compresses a marginal portion of the side wall bounding the port to establish a fluid seal around the opening.

47. The machine of claim 46, wherein said exhaust outlet is configured to direct exhaust gas into a first portion of the coupling in a direction in which fluid would flow under the influence of suction exerted via said suction line.

48. The machine of claim 46, wherein said exhaust outlet of the engine is provided by an outlet of a muffler on the engine.

49. The machine of claim 48, wherein the outlet of the muffler is configured as a pipe.
